(19) United States
(12) Patent Application Publication
(10) Pub. No.: US 2026/0217252 A1
(43) Pub. Date: Jul. 30, 2026

(54) TRAVELING CONTROL DEVICE, TRAVELING CONTROL METHOD, AND STORAGE MEDIUM

(71) Applicant: HONDA MOTOR CO., LTD., Tokyo (JP)

(72) Inventors: Tomotaka Teramachi, Tokyo (JP); Akito Kokubo, Tokyo (JP)

(21) Appl. No.: 19/458,978

(22) Filed: Jan. 26, 2026

(30) Foreign Application Priority Data
Jan. 29, 2025 (JP) 2025-012939

(51) Int. Cl. B60W 30/18; B60W 10/04; B60W 10/18; B60W 10/20; B60W 30/14; B60W 50/10; B60W 50/14; B60W 60/00

(52) U.S. Cl. CPC B60W 30/18163; B60W 10/20; B60W 30/143; B60W 50/10; B60W 50/14; B60W 60/001; B60W 10/04; B60W 10/18; B60W 2555/60

(57) ABSTRACT

A traveling control device includes a proposer configured to output a proposal of lane change to an occupant of a vehicle via an output interface, and a lane change controller configured to execute the lane change by controlling steering of the vehicle when an approval operation that is an operation of the occupant to approve the proposal is input to an input interface, in which the proposer is configured to control, when a speed of the vehicle is outside a second predetermined range that includes a first predetermined range and is wider than the first predetermined range, the output of the proposal such that the lane change is suppressed.

### CROSS-REFERENCE TO RELATED APPLICATION

This application is based upon and claims the benefit of priority from Japanese Patent Application No. 2025-012939, filed Jan. 29, 2025, the entire content of which is incorporated herein by reference.

### BACKGROUND

### Field of the Invention

The present invention relates to a traveling control device, a traveling control method, and a storage medium.

### Description of Related Art

In recent years, efforts have been actively made to provide access to a sustainable transportation system with special attention to people in vulnerable situations among traffic participants. To implement this, research and development for further improving the safety or convenience of traffic through research and development on an autonomous driving technique has been focused on. For example, a technique for proposing, when a vehicle is traveling on a road where lane change is required such as a branching road, lane change to an occupant at a position a predetermined distance away from a position where the road branches is known (for example, see Japanese Unexamined Patent Application, First Publication No. 2023-146020).

### SUMMARY

An appropriate speed is required for lane change, and in the related art, when a speed of the vehicle is within a predetermined range, lane change is proposed to an occupant, and when the speed of the vehicle is outside the predetermined range, the proposal of lane change is withdrawn. However, the speed of the vehicle may vary at the boundary of the predetermined range (when the speed of the vehicle may be alternately in and out of the predetermined range), and as a result, the proposal and withdrawal of the lane change are frequently repeated, causing the occupant to feel troublesomeness.

To solve the above-described problem, an object of the present invention is to reduce troublesomeness of an occupant due to a proposal of lane change by performing the proposal and withdrawal of the lane change at an appropriate timing. The present invention, in turn, contributes to development of a sustainable transportation system.

A traveling control device, a traveling control method, and a storage medium according to the present invention employ the following configurations.
(1) A first aspect of the present invention is a traveling control device including an output interface configured to output information, an input interface that is operated by an occupant of a vehicle, a proposer configured to output a proposal of lane change to the occupant via the output interface when a speed of the vehicle is within a first predetermined range, and a lane change controller configured to execute the lane change by controlling steering of the vehicle when an approval operation that is an operation of the occupant to approve the proposal is input to the input interface, in which the proposer is configured to control, when the speed of the vehicle is outside a second predetermined range that includes the first predetermined range and is wider than the first predetermined range, the output of the proposal such that the lane change is suppressed.
(2) According to a second aspect of the present invention, in the first aspect, a lower limit value of the second predetermined range is smaller than a lower limit value of the first predetermined range, and an upper limit value of the second predetermined range is equal to an upper limit value of the first predetermined range.
(3) According to a third aspect of the present invention, in the second aspect, the traveling control device further includes a driving operation member that is operated by the occupant to adjust acceleration and deceleration of the vehicle, in which the upper limit value of the second predetermined range is allowed to be exceeded only with an operation of the occupant on the driving operation member.
(4) According to a fourth aspect of the present invention, in the first aspect, the lane change controller is configured to cancel a state in which the proposal is approved by the occupant or stop the lane change when the speed of the vehicle is outside a third predetermined range that includes the second predetermined range and is wider than the second predetermined range after the approval operation is input to the input interface.
(5) According to a fifth aspect of the present invention, in the fourth aspect, a lower limit value of the third predetermined range is smaller than a lower limit value of the second predetermined range, and an upper limit value of the third predetermined range is equal to an upper limit value of the second predetermined range.
(6) According to a sixth aspect of the present invention, in the fifth aspect, the traveling control device further includes a driving operation member that is operated by the occupant to adjust acceleration and deceleration of the vehicle, in which the upper limit value of the third predetermined range is allowed to be exceeded only with an operation of the occupant on the driving operation member.
(7) According to a seventh aspect of the present invention, in the fifth aspect, the lower limit value of the third predetermined range is equal to a lower limit value of a speed limit provided for a road on which the vehicle is traveling.
(8) An eighth aspect of the present invention is a traveling control device including an output interface configured to output information, an input interface that is operated by an occupant of a vehicle, a proposer configured to output a proposal of lane change to the occupant via the output interface when a speed of the vehicle is within a first predetermined range, and a lane change controller configured to execute the lane change by controlling steering of the vehicle when an approval operation that is an operation of the occupant to approve the proposal is input to the input interface, in which the lane change controller is configured to cancel a state in which the proposal is approved by the occupant or stop the lane change when the speed of the vehicle is outside a third predetermined range that includes the first predetermined range and is wider than the first predetermined range.
(9) A ninth aspect of the present invention is a traveling control method using a computer, which includes an output interface configured to output information and an input interface that is operated by an occupant of a vehicle, and is mounted in the vehicle, the traveling control method including outputting a proposal of lane change to the occupant via the output interface when a speed of the vehicle is within a first predetermined range, executing the lane change by controlling steering of the vehicle when an approval operation that is an operation of the occupant to approve the proposal is input to the input interface, and controlling, when the speed of the vehicle is outside a second predetermined range that includes the first predetermined range and is wider than the first predetermined range, the output of the proposal such that the lane change is suppressed.
(10) A tenth aspect of the present invention is a non-transitory storage medium storing a program that causes a computer, which includes an output interface configured to output information and an input interface that is operated by an occupant of a vehicle, and is mounted in the vehicle, to execute a process including outputting a proposal of lane change to the occupant via the output interface when a speed of the vehicle is within a first predetermined range, executing the lane change by controlling steering of the vehicle when an approval operation that is an operation of the occupant to approve the proposal is input to the input interface, and controlling, when the speed of the vehicle is outside a second predetermined range that includes the first predetermined range and is wider than the first predetermined range, the output of the proposal such that the lane change is suppressed.

According to the above-described aspects, it is possible to reduce troublesomeness of the occupant due to the proposal of the lane change by performing the proposal and withdrawal of the lane change at an appropriate timing.

### BRIEF DESCRIPTION OF THE DRAWINGS

FIG. 1 is a configuration diagram of a vehicle system using a traveling control device according to an embodiment.

FIG. 2 is a diagram schematically showing a status inside a host vehicle.

FIG. 3 is a functional configuration diagram of a first controller, a second controller, a third controller, and a storage.

FIG. 4 is a diagram illustrating a scenario in which the host vehicle is caused to change a lane.

FIG. 5 is a diagram illustrating a scenario in which the host vehicle is caused to change a lane.

FIG. 6 is a diagram illustrating a scenario in which the host vehicle is caused to change a lane.

FIG. 7 is a diagram showing a display example of a strong recommendation.

FIG. 8 is a diagram showing a classification example of scenes where a strong recommendation is output.

FIG. 9 is a diagram showing an example of an image that is output as a strong recommendation in each scene.

FIG. 10 is a diagram showing an example of an image that is output as a strong recommendation in each scene.

FIG. 11 is a diagram showing an example of an image that is output as a strong recommendation in each scene.

FIG. 12 is a diagram showing an example of an image that is output as a strong recommendation in each scene.

FIG. 13 is a diagram schematically showing an example of a scene where a strong recommendation is output.

FIG. 14 is a diagram schematically showing an example of a scene where a weak recommendation is output.

FIG. 15 is a diagram showing a display example of a weak recommendation.

FIG. 16 is a diagram showing an example of a condition on a speed of a host vehicle when an ALCR is output.

FIG. 17 is a flowchart illustrating an example of a flow of a series of processing by an autonomous driving control device of the embodiment.

### DESCRIPTION OF EMBODIMENTS

Hereinafter, an embodiment of a traveling control device, a traveling control method, and a storage medium of the present invention will be described with reference to the drawings. The traveling control device of the embodiment is applied to, for example, an autonomous driving vehicle. Autonomous driving is, for example, controlling driving of a vehicle by controlling one or both of a speed or steering of the vehicle. Driving control of a vehicle described above includes various kinds of driving control such as an adaptive cruise control system (ACC), traffic jam pilot (TJP), auto lane changing (ALC), a collision mitigation brake system (CMBS), and a lane keeping assistance system (LKAS). The driving of the autonomous driving vehicle may be controlled by manual driving of an occupant (driver). Hereinafter, while a case where a regulation of left-hand traffic is applied will be described, when a regulation of right-hand traffic is applied, the left and right may be reversed.

### Overall Configuration

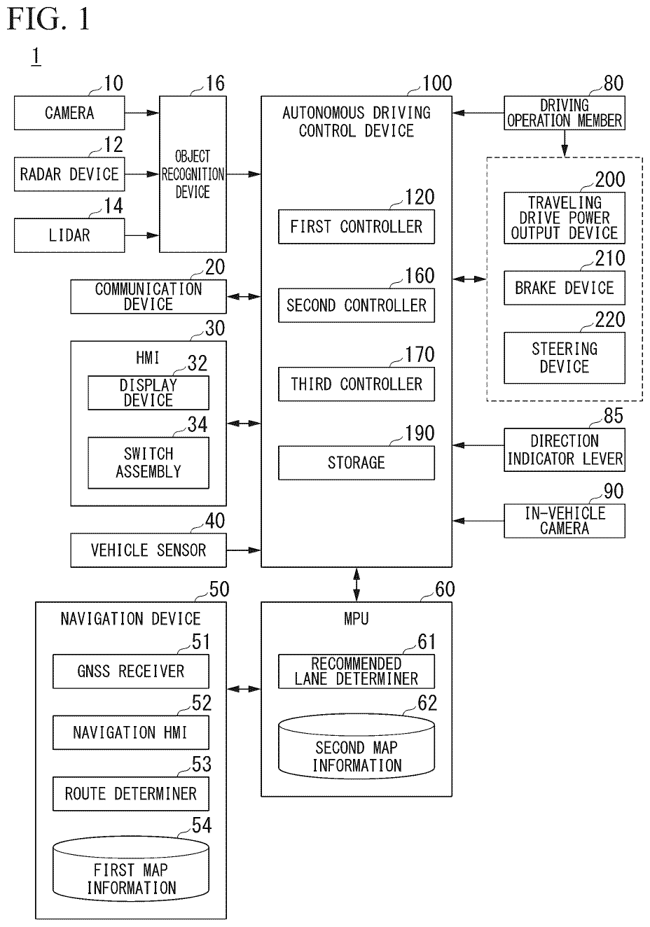

FIG. 1 is a configuration diagram of a vehicle system 1 using the traveling control device according to the embodiment. A vehicle (hereinafter, referred to as a host vehicle M) in which the vehicle system 1 is mounted is, for example, a two-wheeled, three-wheeled, or four-wheeled vehicle, and a drive source thereof includes an internal combustion engine such as a diesel engine or a gasoline engine, an electric motor, or a combination thereof. The electric motor operates using electric power generated by a generator coupled to an internal combustion engine or electric power discharged from a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operation member 80, a direction indicator lever 85, an in-vehicle camera 90, an autonomous driving control device 100, a traveling drive power output device 200, a brake device 210, and a steering device 220. These devices or apparatuses are connected to each other by a multiplex communication line such as a controller area network (CAN), a serial communication line, a wireless communication network, or the like. The configuration shown in FIG. 1 is merely an example, and a part of the configuration may be omitted or another configuration may be added. The autonomous driving control device 100 is an example of a “traveling control device”.

The camera 10 is a digital camera using a solid-state imaging element such as a charge coupled device (CCD) or a complementary metal oxide semiconductor (CMOS). The camera 10 is attached at any place on the host vehicle M. In imaging an area in front the host vehicle M, the camera 10 is attached to an upper portion of a front windshield, a back surface of a rear-view mirror, or the like. In imaging an area behind of the host vehicle M, the camera 10 is attached to an upper portion of a rear windshield, or the like. In imaging an area on a right side or a left side of the host vehicle M, the camera 10 may be attached to a right side surface or a left side surface of a vehicle body or a door mirror, or the like. The camera 10 periodically and repeatedly images the vicinity of the host vehicle M, for example. The camera 10 may be a stereo camera.

The radar device 12 radiates radio waves such as millimeter waves to the vicinity of the host vehicle M and detect radio waves (reflected waves) reflected by an object to detect at least a position of (a distance to and a direction of) the object. The radar device 12 is attached at any place on the host vehicle M. The radar device 12 may detect a position and a speed of an object by a frequency modulated continuous wave (FM-CW) method.

The LIDAR 14 emits light to the vicinity of the host vehicle M and measures scattered light of the emitted light. The LIDAR 14 detects a distance to a target on the basis of a time from light emission to light reception. The emitted light may be, for example, pulsed laser light. The LIDAR 14 is attached at any place on the host vehicle M.

The object recognition device 16 executes sensor fusion processing on detection results of a part or all of the camera 10, the radar device 12, and the LIDAR 14 to recognize a position, a type, a speed, and the like of an object. The object recognition device 16 outputs a recognition result to the autonomous driving control device 100. The object recognition device 16 may output the detection results of the camera 10, the radar device 12, and the LIDAR 14 to the autonomous driving control device 100 without change. The object recognition device 16 may be omitted from the vehicle system 1.

The communication device 20 communicates with another vehicle in the vicinity of the host vehicle M or various server devices via a wireless base station using, for example, a cellular network, a Wi-Fi network, Bluetooth (Registered Trademark), or dedicated short range communication (DSRC).

The HMI 30 presents various kinds of information to an occupant of the host vehicle M and receives an input operation by the occupant. For example, the HMI 30 includes a display device 32 or a switch assembly 34. The display device 32 includes, for example, a first display 32A and a second display 32B. The switch assembly 34 includes, for example, an active lane change recommendation (ALCR) switch 34A. The HMI 30 may further include a speaker, a buzzer, a touch panel, a microphone, and the like. The display device 32 (first display 32A and second display 32B) is an example of an “output interface”. The switch assembly 34 (ALCR switch 34A) is an example of an “input interface”.

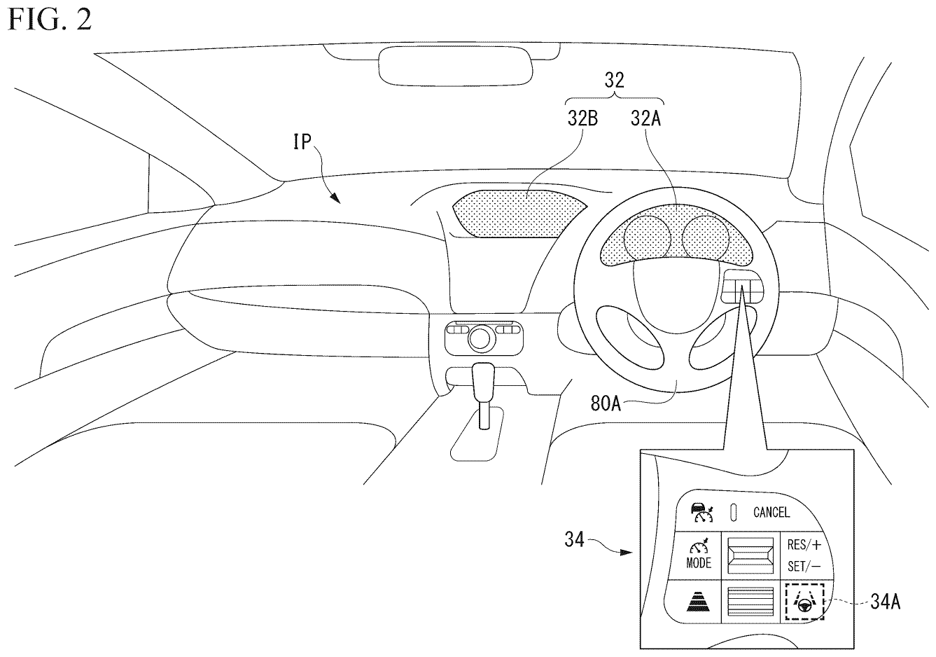

FIG. 2 is a diagram schematically showing a status inside the host vehicle M. For example, the first display 32A is provided near a front surface of a driver's seat (a seat closest to a steering wheel) in an instrument panel IP, and is provided at a position visible by the occupant from a gap of the steering wheel or over the steering wheel.

The first display 32A is, for example, a liquid crystal display (LCD) or an organic electroluminescence (EL) display device. On the first display 32A, information necessary for traveling during manual driving or during driving assistance of the host vehicle M is displayed as an image. Information necessary for traveling of the host vehicle M during manual driving is, for example, a speed, an engine rotation speed, a remaining amount of fuel, a radiator water temperature, a traveling distance, and a remaining amount of battery power of the host vehicle M, and other kinds of information. Information necessary for traveling of the host vehicle M during driving assistance is, for example, information on a future trajectory (a target trajectory described below) of the host vehicle M, the presence or absence of lane change and a lane of a lane change destination, a recognized lane (marking line), or another vehicle. Information necessary for traveling of the host vehicle M during driving assistance may include some or all kinds of information necessary for traveling of the host vehicle M during manual driving.

The second display 32B is provided, for example, near the center of the instrument panel IP. The second display 32B is, for example, an LCD or an organic EL display device like the first display 32A. The second display 32B displays, for example, a navigation result by the navigation device 50 as an image. The second display 32B may display a television program, reproduces a DVD, or contents such as a downloaded movie.

The switch assembly 34 is attached to, for example, the steering wheel. The ALCR switch 34A included in the switch assembly 34 is a switch that is operated by the occupant to determine whether to approve or reject active lane change to be proposed by the autonomous driving control device 100. The ALCR switch 34A may be a push switch operable only in a single direction. Details of a proposal of lane change will be described below. Operating the ALCR switch 34A is an example of an “approval operation”.

The vehicle sensor 40 includes a vehicle speed sensor that detects the speed of the host vehicle M, an acceleration sensor that detects an acceleration, a yaw rate sensor that detects an angular velocity around a vertical axis, a direction sensor that detects a direction of the host vehicle M, and the like.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory.

The GNSS receiver 51 specifies a position of the host vehicle M on the basis of signals received from GNSS satellites. The position of the host vehicle M may be specified or completed by an inertial navigation system (INS) using an output of the vehicle sensor 40.

The navigation HMI 52 includes a display device, a speaker, a touch panel, keys, and the like. The navigation HMI 52 may be partially or entirely shared with the HMI 30 described above. For example, the occupant may input a destination of the host vehicle M to the navigation HMI 52 instead of or in addition to inputting the destination of the host vehicle M to the HMI 30.

The route determiner 53 determines, for example, a route (hereinafter, referred to as an on-map route) from the position of the host vehicle M specified by the GNSS receiver 51 (or any input position) to the destination input by the occupant using the HMI 30 or the navigation HMI 52 with reference to the first map information 54.

The first map information 54 is, for example, information in which a road shape is expressed by a link indicating a road and nodes connected by the link. The first map information 54 may include a curvature of a road, point of interest (POI) information, or the like. The on-map route is output to the MPU 60.

The navigation device 50 may perform route guidance using the navigation HMI 52 on the basis of the on-map route. The navigation device 50 may be implemented by, for example, functions of a terminal device such as a smartphone or a tablet terminal owned by the occupant. The navigation device 50 may transmit a current position and a destination to a navigation server via the communication device 20 and may receive a route equivalent to the on-map route from the navigation server.

The MPU 60 includes, for example, a recommended lane determiner 61, and stores second map information 62 in a storage device such as an HDD or a flash memory. The recommended lane determiner 61 divides the on-map route provided from the navigation device 50 into a plurality of blocks (for example, divides the on-map route every 100 [m] in a vehicle moving direction), and determines a recommended lane for each block with reference to the second map information 62. The recommended lane determiner 61 performs determination which lane from the left the vehicle travels on. When a branching place is present on the on-map route, the recommended lane determiner 61 determines a recommended lane such that the host vehicle M can travel along a reasonable route to proceed to a branch destination.

The second map information 62 is map information with higher accuracy than the first map information 54. The second map information 62 includes, for example, information on a center of a lane, information on a lane boundary. The second map information 62 may include road information, traffic regulation information, address information (address, postal code), facility information, telephone number information, and the like. The second map information 62 may be updated at any time by the communication device 20 through communication with other devices.

The driving operation member 80 includes, for example, an accelerator pedal, a brake pedal, a shift lever, a steering wheel, a deformed steering wheel, a joystick, and other operation members. The driving operation member 80 is attached with a sensor that detects an operation amount or the presence or absence of an operation, and a detection result of the sensor is output to the autonomous driving control device 100 or a part or all of the traveling drive power output device 200, the brake device 210, and the steering device 220.

For example, a sensor (hereinafter, referred to as a steering sensor) attached to the steering wheel detects a weak current (for example, change in static capacitance) generated when the occupant touches the steering wheel. The steering sensor may detect steering torque generated around a rotation axis (shaft) of the steering wheel. When a current or steering torque is detected, the steering sensor outputs a signal indicating the detection result to the autonomous driving control device 100.

The direction indicator lever 85 (also referred to as a stoke or a switch) turns on lamps attached to the front and rear of the host vehicle M when operated by the occupant. Further, the direction indicator lever 85 is operated to indicate lane change to the host vehicle M. Indicating lane change by operating the direction indicator lever 85 is also called a one-touch function. Hereinafter, indicating lane change by operating the direction indicator lever 85 is referred to as a “lane change indication operation”.

The lane change indication may be performed by inputting sound to a microphone or by operating another switch or button in addition to or instead of operating the direction indicator lever 85.

The in-vehicle camera 90 is a camera that images the inside of a vehicle cabin of the host vehicle M. The in-vehicle camera 90 is, for example, a digital camera using a solid-state imaging element such as a CCD or a CMOS. When the inside of the vehicle cabin of the host vehicle M is imaged, the in-vehicle camera 90 outputs image data to the autonomous driving control device 100.

The autonomous driving control device 100 includes, for example, a first controller 120, a second controller 160, a third controller 170, and a storage 190. Each of the first controller 120, the second controller 160, and the third controller 170 is implemented by a hardware processor such as a central processing unit (CPU) or a graphics processing unit (GPU) executing a program. A part or all of these components may be implemented by hardware (circuit; including circuitry) such as a large scale integration (LSI), an application specific integrated circuit (ASIC), a field-programmable gate array (FPGA), or a system on chip (SOC) or may be implemented by software and hardware in cooperation. The program may be stored in advance in a storage device (a storage device including a non-transitory storage medium) such as an HDD or a flash memory of the autonomous driving control device 100 or may be stored in a removable storage medium such as a DVD or a CD-ROM and may be installed on the HDD or the flash memory of the autonomous driving control device 100 when the storage medium (non-transitory storage medium) is loaded into a drive device.

The storage 190 is implemented by each storage device described above. The storage 190 is implemented by, for example, an HDD, a flash memory, an electrically erasable programmable read only memory (EEPROM), a read only memory (ROM), or a random access memory (RAM). The storage 190 stores, for example, programs (instructions) that are read and executed by a processor.

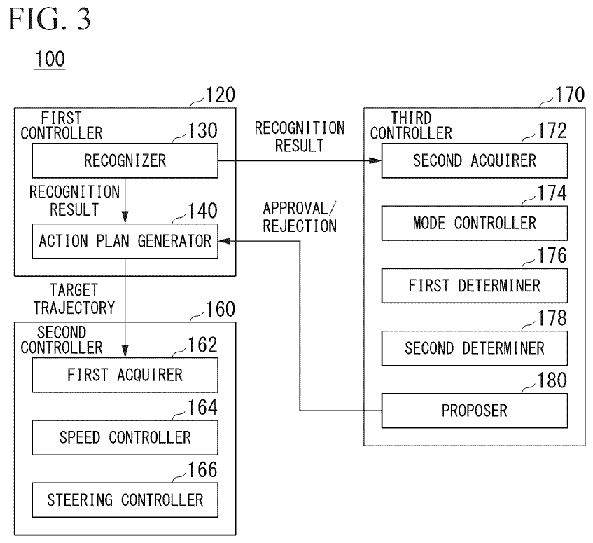

FIG. 3 is a functional configuration diagram of the first controller 120, the second controller 160, the third controller 170, and the storage 190 according to the embodiment. The first controller 120 includes, for example, a recognizer 130 and an action plan generator 140.

The first controller 120 implements, for example, a function by artificial intelligence (AI) and a function by a model given in advance in parallel. For example, a function of “recognizing an intersection” may be implemented by executing recognition of an intersection by deep learning or the like and recognition based on a condition given in advance (there is a signal, a road marking, and the like that can be used for pattern matching) and scoring and comprehensively evaluating both recognitions. Accordingly, the reliability of autonomous driving is secured.

The recognizer 130 recognizes a situation or an environment in the vicinity of the host vehicle M. For example, the recognizer 130 recognizes an object in the vicinity of the host vehicle M on the basis of information input from the camera 10, the radar device 12, and the LIDAR 14 via the object recognition device 16. Examples of an object that is recognized by the recognizer 130 include a bicycle, a motorcycle, a four-wheeled automobile, a pedestrian, a road sign, a road marking, a marking line, a utility pole, a guard rail, and a fallen object. Further, the recognizer 130 recognizes a state of an object such as a position, a speed, or an acceleration. The position of the object is recognized as, for example, a position (that is, a relative position with respect to the host vehicle M) on relative coordinates with a representative point (the center of gravity, the center of a drive shaft, or the like) of the host vehicle M as an origin and is used for control. The position of the object may be represented by a representative point of the object such as the center of gravity or a corner or may be represented by an expressed region. The “state” of the object may include the acceleration or jerk of the object or an “action state” (for example, whether the object is changing a lane or whether the object is about to change a lane).

Further, the recognizer 130 recognizes, for example, a lane (hereinafter, referred to as a host lane) on which the host vehicle M is traveling or an adjacent lane to the host lane. For example, the recognizer 130 recognizes the host lane, the adjacent lane, and the like by comparing a pattern of road marking lines (for example, an arrangement of solid lines and broken lines) obtained from the second map information 62 with a pattern of road marking lines in the vicinity of the host vehicle M recognized from an image captured by the camera 10.

The recognizer 130 may recognize a lane such as the host lane or the adjacent lane by recognizing a roadway boundary (road boundary) including road marking lines, road shoulders, curbstones, median strips, guard rails, and the like without being limited to road marking lines. In this recognition, the position of the host vehicle M acquired from the navigation device 50 or a processing result by the INS may be taken into consideration. The recognizer 130 may recognize temporary stop lines, obstacles, red signals, toll gates, and other road events.

The recognizer 130 recognizes a relative position or a posture of the host vehicle M with respect to the host lane in recognizing the host lane. The recognizer 130 may recognize, for example, deviation of a reference point on the host vehicle M from the lane center and an angle with respect to a line connecting the lane center in the moving direction of the host vehicle M as the relative position and the posture of the host vehicle M with respect to the host lane. Alternatively, the recognizer 130 may recognize a position or the like of the reference point on the host vehicle M with respect to any side end portion (road marking line or road boundary) of the host lane as the relative position of the host vehicle M with respect to the host lane.

When the host vehicle M is under autonomous driving on a route in which a recommended lane is determined, the action plan generator 140 determines a traveling aspect of the autonomous driving. Hereinafter, information defining the traveling aspect of the autonomous driving will be described as an event.

Examples of the event include a constant-speed traveling event, a following traveling event, a lane change event, a branching event, a merging event, and a takeover event. The constant-speed traveling event is a traveling aspect in which the host vehicle M is caused to travel on the same lane at a constant speed. The following traveling event is a traveling aspect in which the host vehicle M is caused to follow another vehicle (hereinafter, referred to as a preceding vehicle) that is present within a predetermined distance (for example, within 100 [m]) ahead the host vehicle M on the host lane and is closest to the host vehicle M.

“Following” may be, for example, a traveling aspect in which an inter-vehicle distance (relative distance) between the host vehicle M and the preceding vehicle is maintained constant or may be a traveling aspect in which, in addition to maintaining the inter-vehicle distance between the host vehicle M and the preceding vehicle constant, the host vehicle M is caused to travel in the center of the host lane.

The lane change event is a traveling aspect in which the host vehicle M is caused to change a lane from the host lane to the adjacent lane. The branching event is a traveling aspect in which the host vehicle M is caused to branch to a lane on a destination side at a branching point of a road. The merging event is a traveling aspect in which the host vehicle M is caused to merge into a main line at a merging point. The takeover event is a traveling aspect in which the autonomous driving ends and is switched to manual driving.

The event may include, for example, a passing event or an avoidance event. The passing event is a traveling aspect in which the host vehicle M is caused to change a lane to an adjacent lane temporarily, pass the preceding vehicle on the adjacent lane, and then, change a lane to the original lane again. The avoidance event is a traveling aspect in which the host vehicle M is caused to perform at least one of braking and steering to avoid an obstacle present ahead the host vehicle M.

The action plan generator 140 may change an event already determined for a current section to another event or may determine a new event for the current section according to a surrounding situation recognized by the recognizer 130 during traveling of the host vehicle M.

For example, when the occupant operates the direction indicator lever 85 to indicate left turn, the action plan generator 140 determines a lane change event in which the host vehicle M is caused to change a lane to an adjacent lane on a left side when viewed from the host vehicle M. For example, when the occupant operates the direction indicator lever 85 to indicate right turn, the action plan generator 140 determines a lane change event in which the host vehicle M is caused to change a lane to an adjacent lane on a right side when viewed from the host vehicle M.

The action plan generator 140 generates a future target trajectory that allows the host vehicle M to travel on a recommended lane determined by the recommended lane determiner 61 in principle, and in addition, to respond to a surrounding situation when the host vehicle M is traveling on the recommended lane, causes the host vehicle M to automatically (independently of an operation of the driver) travel in a traveling aspect defined by an event. The target trajectory includes, for example, a position element that determines a future position of the host vehicle M and a speed element that determines a future speed or the like of the host vehicle M.

For example, the action plan generator 140 determines a plurality of points (trajectory points) that the host vehicle M should reach sequentially, as the position element of the target trajectory. The trajectory point is a point that the host vehicle M should reach for each predetermined traveling distance (for example, about several [m]). The predetermined traveling distance may be calculated by, for example, a distance along the route when the host vehicle M moves along the route.

The action plan generator 140 determines a target speed and a target acceleration for each predetermined sampling time (for example, about several tenths of a [sec]) as a speed element of the target trajectory. The trajectory point may be a position that the host vehicle M should reach for a predetermined sampling time at the sampling time. In this case, the target speed or the target acceleration is determined by the sampling time and an interval of the trajectory points. The action plan generator 140 outputs information indicating the generated target trajectory to the second controller 160.

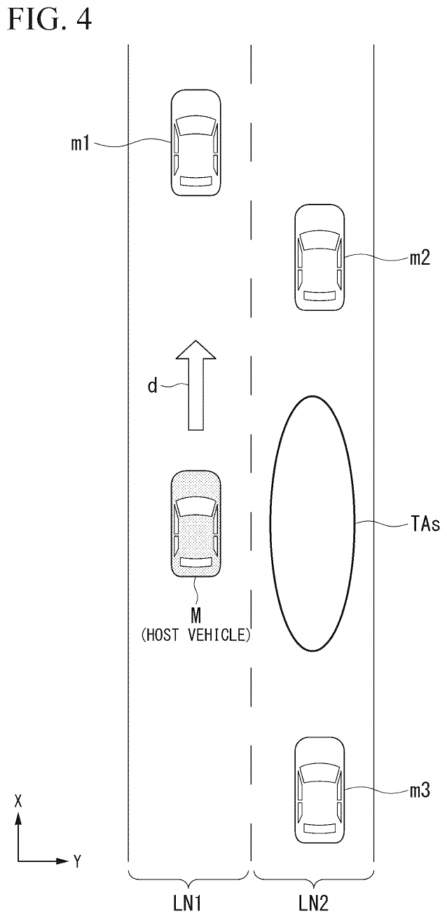

Hereinafter, as an example, a scenario in which the host vehicle M is traveling on a section where a lane change event is planned, that is, a scenario in which the host vehicle M is caused to change a lane will be described. FIGS. 4 to 6 are diagrams illustrating a scenario in which the host vehicle M is caused to change a lane. In the drawings, LN1 represents a host lane, and LN2 represents an adjacent lane to the host lane. Further, X represents an extension direction of a road or a moving direction of the host vehicle M, and Y represent a vehicle width direction perpendicular to the X direction.

When an event of a current section is a lane change event, the action plan generator 140 selects two other vehicles among a plurality of other vehicles that are traveling on the adjacent lane LN2 and sets a lane change target position TAs between the selected two other vehicles. The lane change target position TAs is a target position of lane change destination and is a relative position of the host vehicle M and other vehicles m2 and m3. In the example shown in the drawing, because other vehicles m2 and m3 are traveling on the adjacent lane, the action plan generator 140 sets the lane change target position TAs between other vehicles m2 and m3. When only one other vehicle is present on the adjacent lane LN2, the action plan generator 140 may set the lane change target position TAs at any position in front of or behind another vehicle. When no other vehicles are present on the adjacent lane LN2, the action plan generator 140 may set the lane change target position TAs at any position on the adjacent lane LN2. Hereinafter, another vehicle (in the example shown in the drawing, m2) that is traveling immediately before the lane change target position TAs on the adjacent lane will be described as a forward reference vehicle mB, and another vehicle (in the example shown in the drawing, m3) that is traveling immediately after the lane change target position TAs on the adjacent lane will be described as a rearward reference vehicle mC.

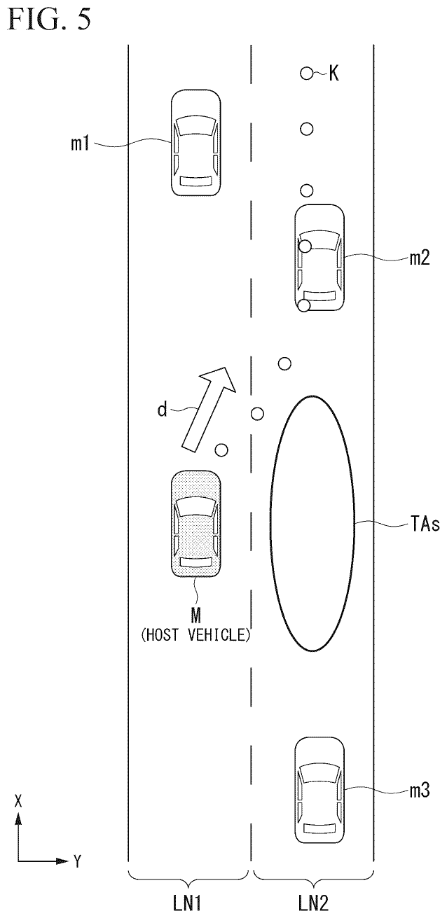

When the lane change target position TAs is set, the action plan generator 140 generates a plurality of target trajectory candidates for causing the host vehicle M to change a lane. In the example of FIG. 5, the action plan generator 140 assumes that each of another vehicle m1 as a preceding vehicle mA, another vehicle m2 as the forward reference vehicle mB, and another vehicle m3 as the rearward reference vehicle mC travels according to a predetermined speed model, and generates a plurality of target trajectory candidates on the basis of the speed models of the three vehicles and the speed of the host vehicle M such that the host vehicle M is present at the lane change target position TAs between the forward reference vehicle mB and the rearward reference vehicle mC at a certain time in the future without interfering with the preceding vehicle mA.

For example, the action plan generator 140 smoothly connects from a current position of the host vehicle M to a position of the forward reference vehicle mB at a certain time in the future, the center of the lane of the lane change destination, and an end point of time of lane change using a polynomial curve such as a spline curve, and arranges a predetermined number of trajectory points K on the curve at regular intervals or irregular intervals. In this case, the action plan generator 140 generates a plurality of target trajectory candidates such that at least one of the trajectory points K is arranged within the lane change target position TAs.

Then, the action plan generator 140 selects an optimum target trajectory among the plurality of generated target trajectory candidates. The optimum target trajectory is, for example, a target trajectory in which a yaw rate predicted to be generated when the host vehicle M is caused to travel on the basis of the target trajectory is less than a threshold, and the speed of the host vehicle M is within a predetermined speed range. The threshold of the yaw rate is set to, for example, a yaw rate at which there is no overload (the acceleration in the vehicle width direction is equal to or greater than a threshold) on the occupant when lane change is performed. The predetermined speed range is set to, for example, a speed range of about 70 to 110 [km/h].

When the lane change target position TAs is set, and the target trajectory for causing the host vehicle M to change a lane to the lane change target position TAs is generated, the action plan generator 140 determines whether lane change is possible to the lane change target position TAs (that is, between the forward reference vehicle mB and the rearward reference vehicle mC).

For example, the action plan generator 140 sets a prohibited region RA where the presence of another vehicle is prohibited, on the adjacent lane LN2, and when a part of another vehicle is not present in the prohibited region RA, and a time to collision (TTC) between the host vehicle M and each of the forward reference vehicle mB and the rearward reference vehicle mC is greater than a threshold, determines that lane change is possible. This determination condition is an example in a case where the lane change target position TAs is set in front of the host vehicle M.

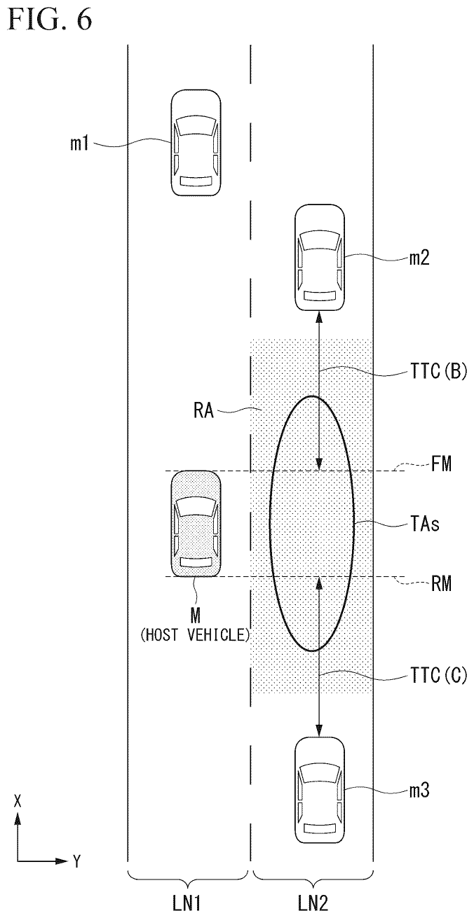

As illustrated in FIG. 6, the action plan generator 140 projects, for example, the host vehicle M onto the lane LN2 of the lane change destination and sets the prohibited region RA having a certain margin distance in front and behind. The prohibited region RA is set as a region extending from one end to the other end of the lane in a horizontal direction (Y direction).

When another vehicle is not present within the prohibited region RA, the action plan generator 140 sets, for example, virtual extension line FM and extension line RM of a front end and a rear end of the host vehicle M on the side of the lane LN2 of the lane change destination. The action plan generator 140 calculates a time to collision TTC(B) between the extension line FM and the forward reference vehicle mB and a time to collision TTC(C) between the extension line RM and the rearward reference vehicle mC. The time to collision TTC(B) is a time that is derived by dividing a distance between the extension line FM and the forward reference vehicle mB by a relative speed of the host vehicle M and the forward reference vehicle mB (in the example of the drawing, another vehicle m2). The time to collision TTC(C) is a time that is derived by dividing a distance between the extension line RM and the rearward reference vehicle mC (in the example of the drawing, another vehicle m3) by a relative speed of the host vehicle M and the rearward reference vehicle mC. The action plan generator 140 determines that lane change is possible when the time to collision TTC(B) is greater than a threshold Th(B), and the time to collision TTC(C) is greater than a threshold Th(C). The thresholds Th(B) and Th(C) may be the same values or may be different values.

When determination is made that lane change is not possible, the action plan generator 140 newly reselects two other vehicles among the plurality of other vehicles that are traveling on the adjacent lane LN2 and resets the lane change target position TAs between the newly selected two other vehicles. One other vehicle between the newly selected two other vehicles may be a previously selected other vehicle.

The action plan generator 140 repeats the setting of the lane change target position TAs until determination is made that lane change is possible. In this case, the action plan generator 140 may generate a target trajectory for causing the host vehicle M to wait on the host lane LN1 or may generate a target trajectory for causing the host vehicle M to decelerate or accelerate such that the host vehicle M is caused to move to the side of the lane change target position TAs on the host lane LN1.

When determination is made that lane change is possible, the action plan generator 140 outputs information indicating the generated target trajectory to the second controller 160.

The second controller 160 controls the traveling drive power output device 200, the brake device 210, and the steering device 220 such that the host vehicle M passes along the target trajectory generated by the action plan generator 140 as a scheduled time.

The second controller 160 includes, for example, a first acquirer 162, a speed controller 164, and a steering controller 166. A combination of the action plan generator 140 and the second controller 160 is an example of a “lane change controller”.

The first acquirer 162 acquires information on the target trajectory (trajectory points) from the action plan generator 140 and stores the acquired information in a memory of the storage 190.

The speed controller 164 controls one or both of the traveling drive power output device 200 and the brake device 210 on the basis of the speed element (for example, the target speed or target acceleration) included in the target trajectory stored in the memory.

The steering controller 166 controls the steering device 220 according to the position element (for example, a curvature representing the degree of curve of the target trajectory) included in the target trajectory stored in the memory.

The processing of the speed controller 164 and the steering controller 166 is implemented by, for example, a combination of feedforward control and feedback control. As an example, the steering controller 166 executes feedforward control according to a curvature of a road in front of the host vehicle M and feedback control based on deviation from the target trajectory in combination.

The traveling drive power output device 200 outputs traveling drive power (torque) for the vehicle to travel to drive wheels. The traveling drive power output device 200 includes, for example, a combination of an internal combustion engine, an electric motor, a transmission, and the like, and a power electronic control unit (ECU) that controls the internal combustion engine, the electric motor, the transmission, and the like. The power ECU controls the above-described configuration according to information input from the second controller 160 or information input from the driving operation member 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor according to information input from the second controller 160 or information input from the driving operation member 80 such that a brake torque according to a braking operation is output to each wheel. The brake device 210 may include, as a backup, a mechanism that transmits the hydraulic pressure generated by an operation of the brake pedal in the driving operation member 80 to the cylinder via a master cylinder. The brake device 210 is not limited to the above-described configuration, and may be an electronically controlled hydraulic brake device that controls an actuator according to information input from the second controller 160 to transmit the hydraulic pressure of the master cylinder to the cylinder.

The steering device 220 includes, for example, a steering ECU and an electric motor. The electric motor applies force to a rack-and-pinion mechanism to change a direction of turning wheels, for example. The steering ECU drives the electric motor according to information input from the second controller 160 or information input from the driving operation member 80 and changes the direction of the turning wheels.

The third controller 170 includes a second acquirer 172, a mode controller 174, a first determiner 176, a second determiner 178, and a proposer 180.

The second acquirer 172 acquires, for example, the recognition result of the recognizer 130 or information input to the HMI 30 by the occupant. The second acquirer 172 provides various kinds of acquired information to the mode controller 174, the first determiner 176, and the second determiner 178.

The mode controller 174 controls a driving mode of the host vehicle M. The driving mode of the host vehicle M includes, for example, a manual driving mode and an autonomous driving mode. The manual driving mode is a mode where the speed and steering of the host vehicle M are controlled according to a driving operation of the occupant.

The autonomous driving mode is a mode where one of the speed or steering of the host vehicle M or both the speed and steering of the host vehicle M are automatically controlled independently of a driving operation of the occupant. The autonomous driving mode includes a plurality of autonomous driving modes such as a first autonomous driving mode, a second autonomous driving mode, a third autonomous driving mode, a fourth autonomous driving mode, and a fifth autonomous driving mode. These autonomous driving modes are different in automation level of control. In addition, under some autonomous driving modes among the plurality of autonomous driving modes, a duty (also referred to as a task) according to the automation level of control is imposed on the occupant of the host vehicle M.

The first autonomous driving mode is an autonomous driving mode having a lowest automation level. Under the first autonomous driving mode, for example, driving assistance control such as ACC or LKAS is performed. Under the first autonomous driving mode, while ACC is performed, LKAS is restricted, and while LKAS is performed, ACC is restricted. That is, under the first autonomous driving mode, steering control and speed control are sequentially processed. Under the first autonomous driving mode, a first duty and a second duty are imposed on the occupant of the host vehicle M. The first duty is a duty to monitor the vicinity (in particular, in front) of the host vehicle M, and the second duty is a duty to operate the steering wheel. “Operating” may be gripping with hands or touching with hands.

The second autonomous driving mode is an autonomous driving mode having an automation level higher than the first autonomous driving mode. Under the second autonomous driving mode, for example, a plurality of kinds of driving assistance control such as ACC, LKAS, and ALC are performed in conjunction with each other. Under the second autonomous driving mode, the degree of duty required for the occupant is the same as or lower than under the first autonomous driving mode. For example, under the second autonomous driving mode, the first duty is imposed on the occupant, and the second duty is not imposed in principle. Under the second autonomous driving mode, the second duty may be further imposed on the occupant at a timing such as immediately before a part of driving assistance control such as ALC is performed.

The third autonomous driving mode is an autonomous driving mode having an automation level higher than the second autonomous driving mode. Under the third autonomous driving mode, when a specific condition is satisfied, both the speed and steering of the host vehicle M are automatically controlled. The specific condition is, for example, a condition that there are few obstacles, and the host vehicle M is traveling on a road where the host lane can be recognized or a relative position of the host vehicle M with respect to the host lane can be recognized. Such a road is, for example, an expressway. Under the third autonomous driving mode, the degree of duty required for the occupant is lower than under the second autonomous driving mode. For example, under the third autonomous driving mode, neither duty of the first duty and the second duty is imposed on the occupant. Under the third autonomous driving mode, a driving operation of the occupant may be required in emergency or the like.

The fourth autonomous driving mode is an autonomous driving mode having an automation level equal to or higher than the third autonomous driving mode. Under the fourth autonomous driving mode, when a specific condition is satisfied, both the speed and steering of the host vehicle M are automatically controlled. Under the fourth autonomous driving mode, similarly to the third autonomous driving mode, the degree of duty required for the occupant is lower than under the second autonomous driving mode. For example, under the fourth autonomous driving mode, neither duty of the first duty and the second duty is imposed on the occupant. Under the fourth autonomous driving mode, both the speed and steering of the host vehicle M are automatically controlled independently of a driving operation of the occupant even in emergency or the like.

The fifth autonomous driving mode is an autonomous driving mode having an automation level equal to or higher than the fourth autonomous driving mode. Under the fifth autonomous driving mode, both the speed and steering of the host vehicle M are automatically controlled regardless of a specific condition. Under the fifth autonomous driving mode, similarly to the third autonomous driving mode or the fourth autonomous driving mode, the degree of duty required for the occupant is lower than under the second autonomous driving mode. For example, under the fifth autonomous driving mode, neither duty of the first duty and the second duty is imposed on the occupant.

For example, when the host vehicle M under the second autonomous driving mode satisfies the specific condition, the mode controller 174 may switch the driving mode to an autonomous driving mode (for example, the third autonomous driving mode) having an automation level higher than the second autonomous driving mode.

For example, when the host vehicle M under the third autonomous driving mode or the fourth autonomous driving mode does not satisfy the specific condition, the mode controller 174 may switch the driving mode to the second autonomous driving mode or the first autonomous driving mode. “The specific condition is not satisfied” is, for example, the host vehicle M is traveling on a road where there are obstacles more than the expressway and the surrounding situation is complicated or a road where a lane and the like cannot be recognized. Such a road is, for example, a general road.

The mode controller 174 may control the driving mode of the host vehicle M on the basis of determination results of the first determiner 176 and the second determiner 178 described below.

The mode controller 174 may control the driving mode on the basis of a detection signal output from the driving operation member 80. For example, when the occupant operates the steering wheel, the accelerator pedal, or the brake pedal with an operation amount greater than a threshold under the autonomous driving mode, the mode controller 174 may switch the driving mode to the manual driving mode.

The mode controller 174 may control the driving mode of the host vehicle M on the basis of an input operation on the HMI 30.

The first determiner 176 analyzes an image generated by the in-vehicle camera 90 to detect a direction of a line of sight or a direction of a face of the occupant on the driver's seat under the autonomous driving mode where the first duty is imposed. The first determiner 176 determines whether the occupant on the driver's seat is monitoring the vicinity of the host vehicle M on the basis of the detected direction of the line of sight or the face. That is, the first determiner 176 determines whether the occupant performs the first duty. For example, when the occupant is looking at outside the vehicle over the front windshield, the first determiner 176 determines that the occupant is monitoring the vicinity of the host vehicle M. That is, the first determiner 176 determines that the occupant performs the first duty.

The second determiner 178 determines whether the occupant is gripping the steering wheel with the hands or is touching the steering wheel with the hands on the basis of a detection result of the steering sensor under the autonomous driving mode where the second duty is imposed. That is, the second determiner 178 determines whether the occupant performs the second duty. For example, when a current value or steering torque detected by the steering sensor is equal to or greater than a threshold, the second determiner 178 determines that the occupant is gripping the steering wheel with the hands or touches the steering wheel with the hands. That is, the second determiner 178 determines that the occupant performs the second duty. Hereinafter, a state in which the occupant performs the second duty, that is, the occupant is gripping the steering wheel may be described as “hands-on”, and a state in which the occupant does not perform the second duty, that is, the occupant is not gripping the steering wheel may be described as “hands-off”.

The proposer 180 outputs a proposal of active lane change (hereinafter, referred to as an active lane change recommendation (ALCR)) to the occupant via the display device 32 (at least one of the first display 32A and the second display 32B) or the speaker of the HMI 30.

Specifically, the proposer 180 outputs the ALCR when the action plan generator 140 determines that lane change is required under the second autonomous driving mode, the third autonomous driving mode, the fourth autonomous driving mode, or the fifth autonomous driving mode (that is, under the autonomous driving mode where automatic lane change can be executed).

The ALCR includes a weak recommendation and a strong recommendation. The weak recommendation is a proposal for simply let the occupant know a situation in which lane change is possible, without recommending lane change to the occupant. The strong recommendation is a proposal for recommending lane change to the occupant. In other words, the strong recommendation is a proposal for recommending lane change to the occupant more strongly than the weak recommendation.

### Details of ALCR: Strong Recommendation

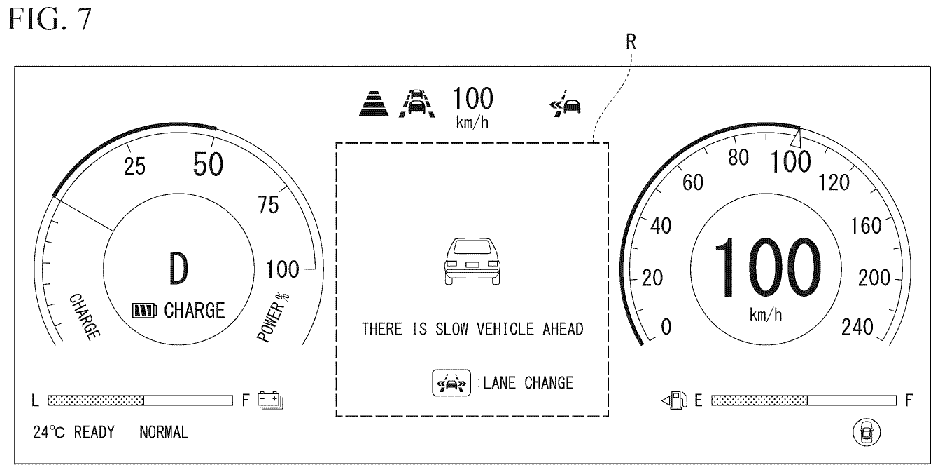

FIG. 7 is a diagram showing a display example of a strong recommendation. The strong recommendation may be displayed on, for example, the first display 32A. As described above, on the first display 32A, the speed, the remaining amount of battery power, and the like of the host vehicle M are displayed as meters. In addition, in a region R between these meters, the surrounding situation of the host vehicle M in which lane change is recommended as the strong recommendation is displayed.

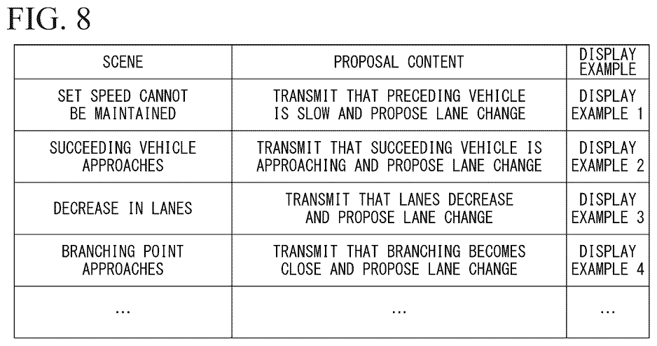

FIG. 8 is a diagram showing a classification example of scenes where a strong recommendation is output. For example, when the host vehicle M is set to travel at a constant speed, the strong recommendation may be output in a scene where a speed of a preceding vehicle is slow and a set speed of the host vehicle M cannot be maintained, a scene where a succeeding vehicle approaches, a scene where a lane on which the host vehicle M is traveling disappears in front of the host vehicle M in the moving direction (that is, a scene of decrease in lanes), a scene where the host vehicle M becomes close to a target branching point, or the like.

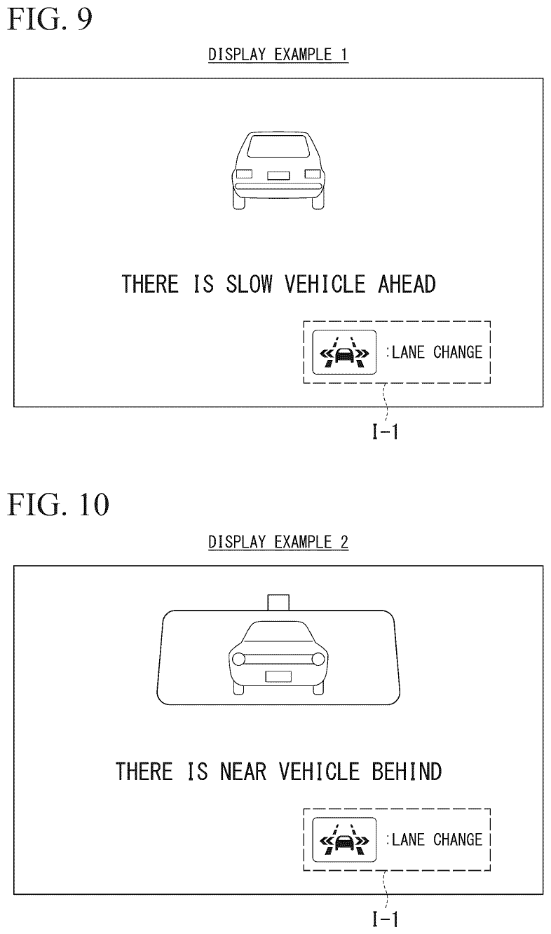

FIGS. 9 to 12 are diagrams showing an example of an image that is output as a strong recommendation in each scene. As in FIG. 9, in the scene where the set speed cannot be maintained, as the strong recommendation, an image representing a forward vehicle is displayed or text representing that a speed of the forward vehicle is slow is displayed. In addition, an icon I-1 indicating that lane change is possible is also displayed.

As in FIG. 10, in the scene where the succeeding vehicle approaches, as the strong recommendation, an image representing the succeeding vehicle is displayed or text representing that the succeeding vehicle is approaching is displayed, or the icon I-1 indicating that lane change is possible is displayed.

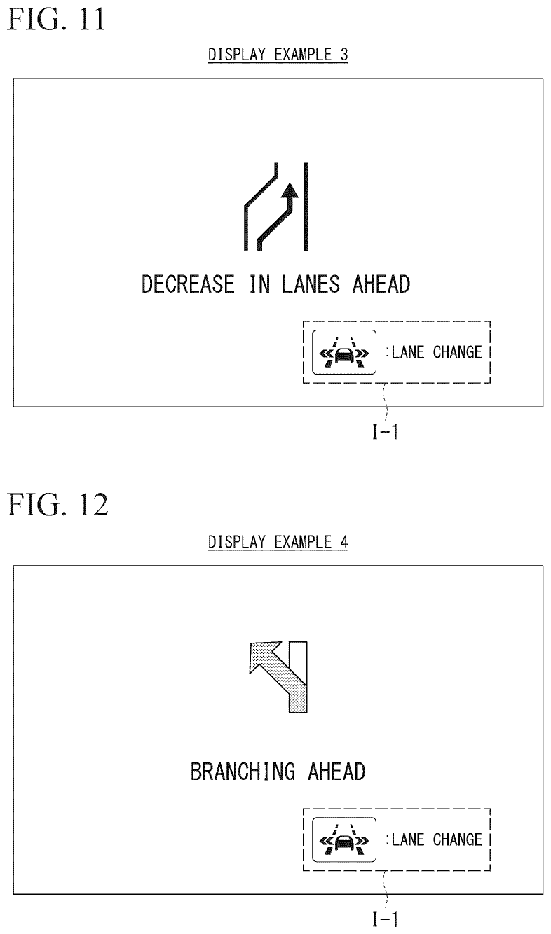

As in FIG. 11, in the scene where lanes decrease, as the strong recommendation, an image or text representing that the lane on which the host vehicle M is traveling disappears in front of the host vehicle M in the moving direction is displayed or the icon I-1 indicating that lane change is possible is displayed.

As in FIG. 12, in the scene where the host vehicle M becomes close to the target branching point, as the strong recommendation, an image or text representing that the target branching point is present in front of the host vehicle M in the moving direction is displayed or the icon I-1 indicating that lane change is possible is displayed.

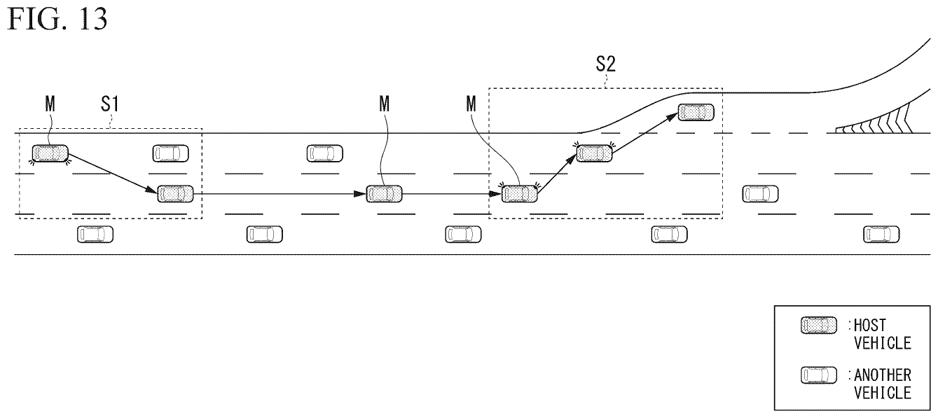

FIG. 13 is a schematically showing an example of a scene where a strong recommendation is output. In a scene S1 of the drawing, the preceding vehicle is slow, and the host vehicle M decelerates and cannot maintain the set speed. In such a scene S1, the strong recommendation illustrated in FIG. 9 is output. In a scene S2, the host vehicle M becomes close to the target branching point. In such a scene S2, the strong recommendation illustrated in FIG. 12 is output.

In response to the output of the strong recommendation, for example, when the occupant operates the ALCR switch 34A, the proposer 180 determines that the lane change is approved by the occupant. In this case, the proposer 180 provides the determination result that the lane change is approved by the occupant, to the action plan generator 140. The action plan generator 140 receives the determination result to generate a target trajectory for causing the host vehicle M to change a lane, and the second controller 160 controls the steering and speed of the host vehicle M on the basis of the target trajectory. Accordingly, automatic lane change is executed in the scene S1 or S2.

### Details of ALCR: Weak Recommendation

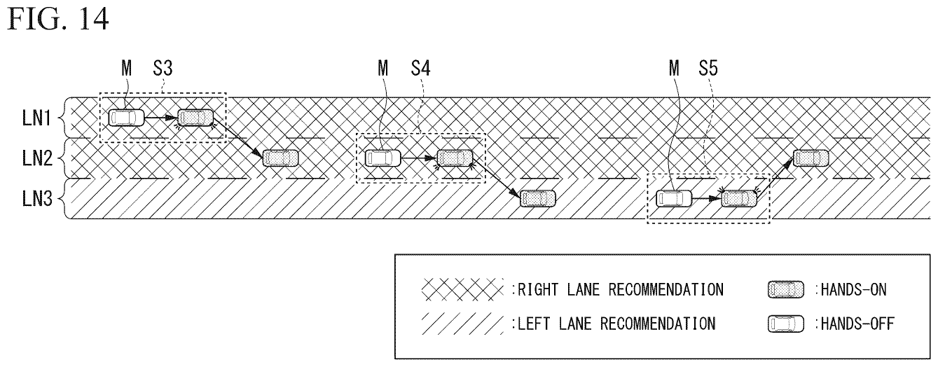

FIG. 14 is a diagram schematically showing an example of a scene where a weak recommendation is output. In scenes S3 to S5 of the drawing, another vehicle is not present in the vicinity of the host vehicle M, lanes do not decrease, and in addition, a target branching point is not present nearby. In such scenes S3 to S5, because the host vehicle M can freely change a lane to another lane, a weak recommendation is output.

For example, as in the scene S3, when the host vehicle M is present on a leftmost lane LN1, as the weak recommendation, lane change to a center lane LN2 is proposed. As in the scene S4, when the host vehicle M is present on the center lane LN2, as the weak recommendation, lane change to a rightmost lane LN3 (passing lane) is proposed. As in the scene S5, when the host vehicle M is present on the rightmost lane LN3, as the weak recommendation, lane change to the center lane LN2 is proposed.

In response to the output of the weak recommendation, for example, when the occupant operates the ALCR switch 34A, the proposer 180 determines that the lane change is approved by the occupant. In this case, the proposer 180 provides the determination result that the lane change is approved by the occupant, to the action plan generator 140. The action plan generator 140 receives the determination result to generate a target trajectory for causing the host vehicle M to change a lane, and the second controller 160 controls the steering and speed of the host vehicle M on the basis of the target trajectory. Accordingly, automatic lane change is executed in the scenes S3 to S5.

As described above, under the second autonomous driving mode, the second duty may be imposed on the occupant immediately before the automatic lane change is executed. In such a case, when the weak recommendation is output and the ALCR switch 34A is operated, and when the occupant fulfills the second duty, that is, the hands-on state is brought, automatic lane change is executed.

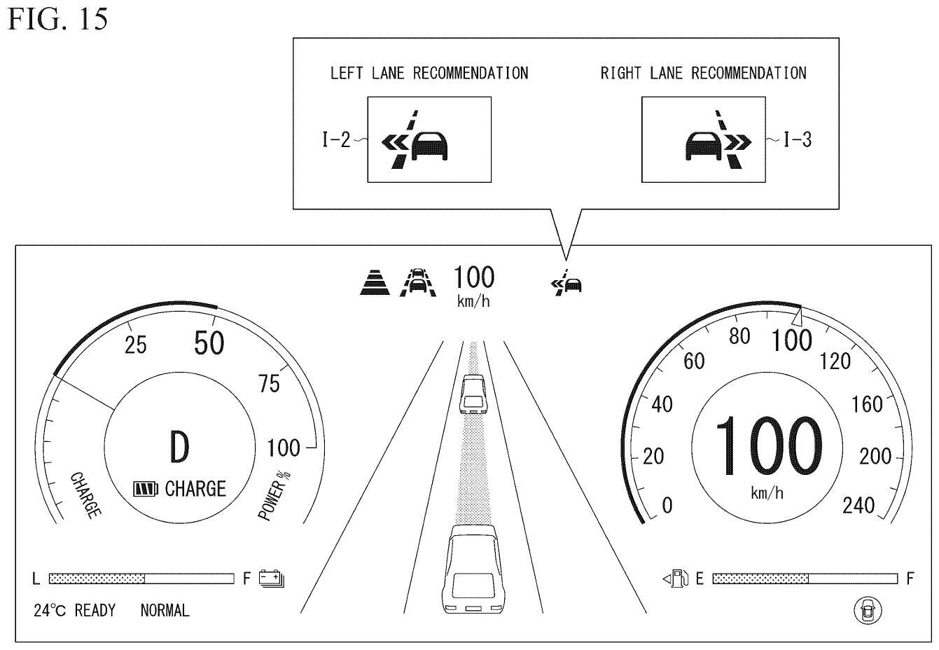

FIG. 15 is a diagram showing a display example of a weak recommendation. Similarly to the strong recommendation, the weak recommendation may also be displayed on the first display 32A. For example, on the first display 32A, the meters representing the speed, the remaining amount of battery power, and the like of the host vehicle M, the target trajectory, a recognized lane (marking line), another vehicle, and the like may be displayed, and in addition, as the weak recommendation, an icon I-2 representing a recommendation of lane change to a left lane or an icon I-3 representing a recommendation of lane change to a right lane may be displayed.

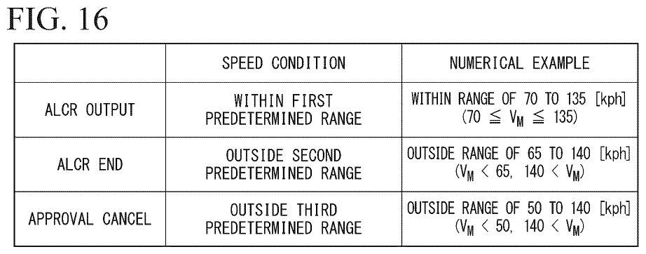

FIG. 16 is a diagram showing an example of a condition on a speed V_{M} of the host vehicle M when the ALCR is output. As shown in the drawing, when the speed V_{M} of the host vehicle M is within a first predetermined range, the ALCR is output. The first predetermined range may have, for example, a lower limit value of 70 [kph] and an upper limit value of 135 [kph].

When the speed V_{M} of the host vehicle M is outside a second predetermined range, the output of the ALCR ends. The second predetermined range is a range that includes the first predetermined range and is wider than the first predetermined range. The second predetermined range may have, for example, a lower limit value of 65 [kph] and an upper limit value of 140 [kph].

When the speed V_{M} of the host vehicle M is outside a third predetermined range, a state (hereinafter, referred to as an approval state) in which the ALCR is approved by the occupant is canceled (revoked), and the approved lane change is stopped. The approval state of the ALCR is a state in which the ALCR switch 34A is operated when the ALCR is output. The third predetermined range is a range that includes the second predetermined range and is wider than the second predetermined range. The third predetermined range may have, for example, a lower limit value of 50 [kph] and an upper limit value of 140 [kph].

The lower limit value of the third predetermined range may be set to the same value as a lower limit value of a speed limit provided for a road on which the host vehicle M is traveling. For example, when the host vehicle M is traveling on an expressway and a lowest speed of the expressway is determined as 50 [kph], the lower limit value of the third predetermined range is set to 50 [kph].

### Processing Flow

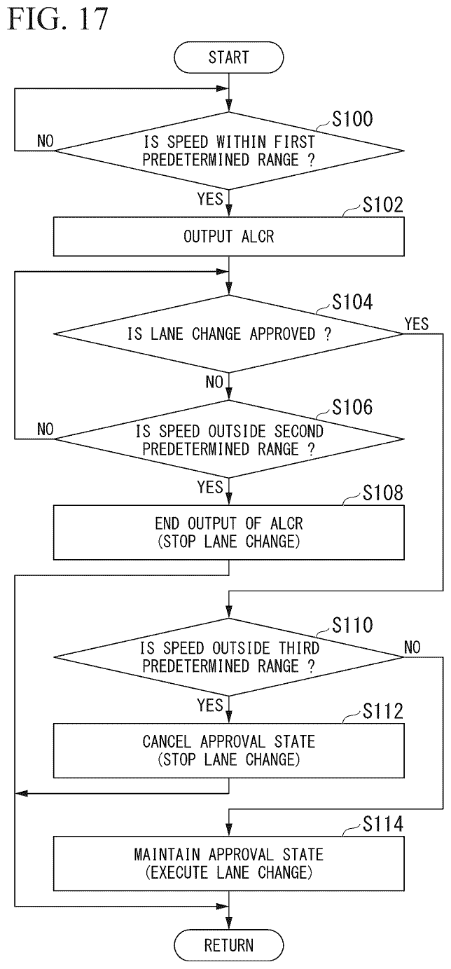

Hereinafter, a flow of a series of processing by the autonomous driving control device 100 of the embodiment will be described using a flowchart. FIG. 17 is a flowchart illustrating an example of a flow of a series of processing by the autonomous driving control device 100 of the embodiment. The processing of this flowchart may be executed repeatedly in a predetermined cycle, for example, when the ALCR is output.

First, the proposer 180 waits until the speed V_{M} of the host vehicle M is within the first predetermined range. That is, the proposer 180 waits until the speed V_{M} of the host vehicle M is equal to or higher than the lower limit value 70 [kph] of the first predetermined range and is equal to or lower than the upper limit value 135 [kph] of the first predetermined range.

When the speed V_{M} of the host vehicle M is within the first predetermined range, the proposer 180 outputs the ALCR (Step S102).

Next, the proposer 180 determines whether the lane change is approved by the occupant after the ALCR is output (Step S104). That is, the proposer 180 determines whether the ALCR switch 34A is operated by the occupant.

When the ALCR switch 34A is not operated by the occupant and the lane change is not approved, the proposer 180 determines whether the speed V_{M} of the host vehicle M is outside the second predetermined range (Step S106). That is, the proposer 180 determines whether the speed V_{M} of the host vehicle M is lower than the lower limit value 65 [kph] of the second predetermined range or exceeds the upper limit value 140 [kph] of the second predetermined range.

When the speed V_{M} of the host vehicle M is not outside the second predetermined range, that is, when the speed V_{M} of the host vehicle M is equal to or higher than the lower limit value 65 [kph] of the second predetermined range and equal to or lower than the upper limit value 140 [kph] of the second predetermined range, the proposer 180 returns the processing to S104, and continues to determine whether the lane change is approved by the occupant.

When the speed V_{M} of the host vehicle M is outside the second predetermined range, that is, when the speed V_{M} of the host vehicle M is lower than the lower limit value 65 [kph] of the second predetermined range or exceeds the upper limit value 140 [kph] of the second predetermined range, the proposer 180 ends the output of the ALCR (Step S108). Accordingly, the lane change proposed as the ALCR is not approved by the occupant, and as a result, the lane change is suppressed (the lane change is stopped).

To suppress the lane change, the proposer 180 may invalidate the operation of the occupant on the ALCR switch 34A instead of or in addition to ending the output of the ALCR.

On the other hand, in the processing of S104, when the ALCR switch 34A is operated by the occupant and the lane change is approved, the proposer 180 determines whether the speed V_{M} of the host vehicle M is outside the third predetermined range (Step S110). That is, the proposer 180 determines whether the speed V_{M} of the host vehicle M is lower than the lower limit value 50 [kph] of the third predetermined range or exceeds the upper limit value 140 [kph] of the third predetermined range.

When the speed V_{M} of the host vehicle M is outside the third predetermined range, that is, when the speed V_{M} of the host vehicle M is lower than the lower limit value 50 [kph] of the third predetermined range or exceeds the upper limit value 140 [kph] of the third predetermined range, the proposer 180 cancels the approval state of the ALCR (Step S112). In response to this, the action plan generator 140 or the second controller 160 suppresses the execution of the lane change (stops the lane change).

Specifically, generating the target trajectory for causing the host vehicle M to change a lane in the action plan generator 140 may be cancelled or controlling the speed and steering of the host vehicle M on the basis of the target trajectory generated by the action plan generator 140 in the second controller 160 may be cancelled.

When the speed V_{M} of the host vehicle M is not outside the third predetermined range, that is, when the speed V_{M} of the host vehicle M is equal to or higher than the lower limit value 50 [kph] of the third predetermined range and is equal to or lower than the upper limit value 140 [kph] of the third predetermined range, the proposer 180 maintains the approval state of the ALCR (Step S114). In response to this, the action plan generator 140 generates a target trajectory for causing the host vehicle M to change a lane, and the second controller 160 controls the steering and speed of the host vehicle M on the basis of the target trajectory. Accordingly, the automatic lane change proposed to the occupant as the ALCR is executed. Therefore, the series of processing of the flowchart ends.

According to the embodiment described above, the autonomous driving control device 100 outputs the proposal (ALCR) of active lane change to the occupant via the display device 32 (the first display 32A and the second display 32B) or the speaker when the speed V_{M} of the host vehicle M is within the first predetermined range. The autonomous driving control device 100 executes the automatic lane change when the operation of the occupant to approve the ALCR is input to the switch assembly 34 (ALCR switch 34A).

In addition, when the speed V_{M} of the host vehicle M is outside the second predetermined range, the autonomous driving control device 100 ends the output of the ALCR such that the lane change is suppressed. Further, the autonomous driving control device 100 suppresses the execution of the lane change by canceling the approval state of the ALCR when the speed V_{M} of the host vehicle M is outside the third predetermined range after the lane change is approved by the occupant. With such a configuration, it is possible to perform the proposal and withdrawal of the lane change at an appropriate timing. In other words, it is possible to suppress hunting of the proposal of the lane change. As a result, it is possible to reduce troublesomeness of the occupant due to the proposal of the lane change.

According to the above-described embodiment, because the second predetermined range is wider than the first predetermined range, and the third predetermined range is still wider than the second predetermined range, even when the host vehicle M is slightly accelerated or decelerated immediately after the ALCR is output and the occupant approves the ALCR, it is possible to execute the lane change without canceling the approval state of the ALCR.

### Modification Example of Embodiment

Hereinafter, a modification example of the above-described embodiment will be described. In the above-described embodiment, although a case where the output of the ALCR ends to suppress the lane change when the speed V_{M} of the host vehicle M is outside the second predetermined range has been described, the present invention is not limited thereto. For example, the upper limit value 140 [kph] of the second predetermined range may be allowed to be exceeded only with an operation of the occupant on the accelerator pedal in the driving operation member 80.

In the above-described embodiment, although a case where the approval state of the ALCR is canceled when the speed V_{M} of the host vehicle M is outside the third predetermined range has been described, the present invention is not limited thereto. For example, the upper limit value 140 [kph] of the third predetermined range may be allowed to be exceeded only with an operation of the occupant on the accelerator pedal in the driving operation member 80.

In this way, the upper limit value can be exceeded with an occupant's operation. For this reason, in this case, while allowing the proposal to be withdrawn after the lane change is proposed under determination that the occupant is likely to have an intention not to follow the proposal of the lane change, a difference is provided between the speed of the proposal and the speed of the proposal withdrawal. Therefore, it is possible to suppress hunting due to a decrease after an increase in speed during an occupant override.

Although the mode for carrying out the present invention has been described using the embodiment, the present invention is not limited to the embodiment, and various modifications and substitutions can be made without departing from the spirit or scope of the present invention.

What is claimed is:

1. A traveling control device comprising:
an output interface configured to output information;
an input interface that is operated by an occupant of a vehicle;
a proposer configured to output a proposal of lane change to the occupant via the output interface when a speed of the vehicle is within a first predetermined range; and
a lane change controller configured to execute the lane change by controlling steering of the vehicle when an approval operation that is an operation of the occupant to approve the proposal is input to the input interface,
wherein the proposer is configured to control, when the speed of the vehicle is outside a second predetermined range that includes the first predetermined range and is wider than the first predetermined range, the output of the proposal such that the lane change is suppressed.

2. The traveling control device according to claim 1,
wherein a lower limit value of the second predetermined range is smaller than a lower limit value of the first predetermined range, and an upper limit value of the second predetermined range is equal to an upper limit value of the first predetermined range.

3. The traveling control device according to claim 2, further comprising:
a driving operation member that is operated by the occupant to adjust acceleration and deceleration of the vehicle,
wherein the upper limit value of the second predetermined range is allowed to be exceeded only with an operation of the occupant on the driving operation member.

4. The traveling control device according to claim 1,
wherein the lane change controller is configured to cancel a state in which the proposal is approved by the occupant or stop the lane change when the speed of the vehicle is outside a third predetermined range that includes the second predetermined range and is wider than the second predetermined range after the approval operation is input to the input interface.

5. The traveling control device according to claim 4,
wherein a lower limit value of the third predetermined range is smaller than a lower limit value of the second predetermined range, and an upper limit value of the third predetermined range is equal to an upper limit value of the second predetermined range.

6. The traveling control device according to claim 5, further comprising:
a driving operation member that is operated by the occupant to adjust acceleration and deceleration of the vehicle,
wherein the upper limit value of the third predetermined range is allowed to be exceeded only with an operation of the occupant on the driving operation member.

7. The traveling control device according to claim 5,
wherein the lower limit value of the third predetermined range is equal to a lower limit value of a speed limit provided for a road on which the vehicle is traveling.

8. A traveling control device comprising:
an output interface configured to output information;
an input interface that is operated by an occupant of a vehicle;
a proposer configured to output a proposal of lane change to the occupant via the output interface when a speed of the vehicle is within a first predetermined range; and
a lane change controller configured to execute the lane change by controlling steering of the vehicle when an approval operation that is an operation of the occupant to approve the proposal is input to the input interface,
wherein the lane change controller is configured to cancel a state in which the proposal is approved by the occupant or stop the lane change when the speed of the vehicle is outside a third predetermined range that includes the first predetermined range and is wider than the first predetermined range.

9. A traveling control method using a computer, which includes an output interface configured to output information and an input interface that is operated by an occupant of a vehicle, and is mounted in the vehicle, the traveling control method comprising:
outputting a proposal of lane change to the occupant via the output interface when a speed of the vehicle is within a first predetermined range;
executing the lane change by controlling steering of the vehicle when an approval operation that is an operation of the occupant to approve the proposal is input to the input interface; and
controlling, when the speed of the vehicle is outside a second predetermined range that includes the first predetermined range and is wider than the first predetermined range, the output of the proposal such that the lane change is suppressed.

10. A non-transitory storage medium storing a program that causes a computer, which includes an output interface configured to output information and an input interface that is operated by an occupant of a vehicle, and is mounted in the vehicle, to execute a process comprising:
outputting a proposal of lane change to the occupant via the output interface when a speed of the vehicle is within a first predetermined range;
executing the lane change by controlling steering of the vehicle when an approval operation that is an operation of the occupant to approve the proposal is input to the input interface; and
controlling, when the speed of the vehicle is outside a second predetermined range that includes the first predetermined range and is wider than the first predetermined range, the output of the proposal such that the lane change is suppressed.
